(19) United States
(12) Patent Application Publication
(10) Pub. No.: US 2014/0188956 A1
(43) Pub. Date: Jul. 3, 2014

(54) PERSONALIZED REAL-TIME RECOMMENDATION SYSTEM

(71) Applicant: MICROSOFT CORPORATION, Redmond, WA (US)

(72) Inventors: Rajen Subba, Sunnyvale, CA (US); Dragomir Yankov, Sunnyvale, CA (US); Pavel Berkhin, Sunnyvale, CA (US); Steven William Macbeth, Redmond, WA (US); Zhaowei Charlie Jiang, Palo Alto, CA (US); Benoit Dumoulin, Palo Alto, CA (US)

(73) Assignee: MICROSOFT CORPORATION, Redmond, WA (US)

(21) Appl. No.: 13/730,815

(22) Filed: Dec. 28, 2012

(51) Int. Cl. G06F 17/30

(52) U.S. Cl. CPC G06F 17/30221
USPC 707/829

(57) ABSTRACT

Content is proactively presented to a user, to enable the user to more efficiently access such content. A user context is correlated to content that is likely to be subsequently accessed. One such a correlation is specific to a given user, while another such correlation is general to a collection, or class, of users. Correlations between a current user context and content subsequently accessed are based on historical data and are defined in terms of mathematical functions or semantic relationships. Such correlations are then utilized to identify content that is likely to be subsequently accessed, and such content is proactively presented to a user. A user interface provides a defined area within which proactive presentations of content are made, including while the user is utilizing other application programs.

### BACKGROUND

Computing devices have long utilized a hierarchical file system in which applications, files and other content are stored in one or more folders which can, in turn, be stored in other folders. While such a file system can provide users with the ability to store a large quantity of data in an organized manner, it can also render it difficult for users to find specific content quickly. Additionally, such a file system can be difficult to navigate using modern portable computing devices that may comprise displays of limited size, so as to enhance their portability.

Instead, modern portable computing devices often implement a simplified user interface that presents a wide variety of content, such as different application programs, at a single level, such as through multiple “screens” that a user can navigate to utilizing touch gestures or other like user input appropriate for a portable computing context. While such a simplified user interface can be utilized efficiently, especially in a portable computing context, when a user has installed a limited number of application programs and other content, users having a large number of application programs and content can find such a simplified user interface challenging. In particular, it can require additional effort on the part of the user to identify and locate a particular application program, or content. Users often have to resort to utilizing search functionality to identify and locate application programs and content that is sought, or, alternatively, users have to resort to flipping back and forth between multiple screens of information to identify and locate the application program and content that they seek.

### SUMMARY

In one embodiment, a correlation can be established between a current user context and content that the user will likely subsequently access. Such content can then be proactively presented to the user, thereby enabling the user to efficiently access such content.

In another embodiment, the correlation between the current user context and the content that the user will likely subsequently access can be established based on historical data collected from the same user, including content accessed by the user, the order in which it was accessed, the user's location when accessing such content, the time and day when such accessing took place, other content available or installed on the user's computing device, and other like user context data.

In a further embodiment, a correlation between a current user context and the content that will likely subsequently be accessed can be based on historical data collected from a myriad of users. Such a correlation can reflect what an average user will likely subsequently access given a current user context. The content that an average user will likely subsequently access can be proactively presented, either in addition to, or in place of, the content that the specific user to whom the presentation is made will likely subsequently access.

In a still further embodiment, a user interface can provide a defined area within which content can be proactively presented to a user. Such a defined area can include the ability to proactively present content with differing importance, and can include the ability to proactively present content while the user is utilizing other application programs.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Additional features and advantages will be made apparent from the following detailed description that proceeds with reference to the accompanying drawings.

### DESCRIPTION OF THE DRAWINGS

The following detailed description may be best understood when taken in conjunction with the accompanying drawings, of which:

FIG. 1 is a block diagram of an exemplary system for proactively presenting content to a user on the user's computing device;

FIG. 2 is a block diagram of an exemplary proactive content presentation mechanism;

FIG. 3 is a block diagram of an exemplary semantic relationship between content;

FIG. 4 is a block diagram of exemplary user interfaces for proactively presenting content to a user;

FIG. 5 is a flow diagram of an exemplary series of steps for proactively presenting content to a user; and

FIG. 6 is a block diagram of an exemplary computing device.

### DETAILED DESCRIPTION

The following description relates to the proactive presentation of content, including application programs and other content, to a user. Such proactive presentation enables a user to more efficiently access such content, saves the user from having to search for such content and can remind the user of forgotten content or introduce the user to new content, such as new application programs that can provide greater benefits than application programs currently being utilized by the user. A user context can be correlated to content that is likely to be subsequently accessed. One such a correlation can be specific to a given user, while another such correlation can be general to a collection, or class, of users. Correlations between a current user context and content subsequently accessed can be based on historical data and can be defined in terms of mathematical functions or semantic relationships. Such correlations can then be utilized to identify content that is likely to be subsequently accessed, and such content can be proactively presented to a user. A user interface can provide a defined area within which proactive presentations of content can be made, including while the user is utilizing other application programs.

For purposes of illustration, the mechanisms described herein make reference to specific exemplary uses of a proactive content presentation mechanism. In particular, mechanisms described herein focus upon the proactive presentation of application programs within the context of a user interface presented by a mobile computing device. The mechanisms described, however, are not limited to the proactive presentation of application programs. For example, the mechanisms described are equally applicable to the proactive presentation of online content such as webpages, including both static and dynamic webpages, and other like content. Similarly, the mechanisms described are equally utilizable by other types of computing devices. Consequently, references to specific types of content and specific types of computing devices are meant to be exemplary only and are not meant to limit the scope of the teachings provided herein.

Although not required, the description below will be in the general context of computer-executable instructions, such as program modules, being executed by a computing device. More specifically, the description will reference acts and symbolic representations of operations that are performed by one or more computing devices or peripherals, unless indicated otherwise. As such, it will be understood that such acts and operations, which are at times referred to as being computer-executed, include the manipulation by a processing unit of electrical signals representing data in a structured form. This manipulation transforms the data or maintains it at locations in memory, which reconfigures or otherwise alters the operation of the computing device or peripherals in a manner well understood by those skilled in the art. The data structures where data is maintained are physical locations that have particular properties defined by the format of the data.

Generally, program modules include routines, programs, objects, components, data structures, and the like that perform particular tasks or implement particular abstract data types. Moreover, those skilled in the art will appreciate that the computing devices need not be limited to conventional personal computers, and include other computing configurations, including hand-held devices, multi-processor systems, microprocessor based or programmable consumer electronics, network PCs, minicomputers, mainframe computers, and the like. Similarly, the computing devices need not be limited to stand-alone computing devices, as the mechanisms may also be practiced in distributed computing environments where tasks are performed by remote processing devices that are linked through a communications network. In a distributed computing environment, program modules may be located in both local and remote memory storage devices.

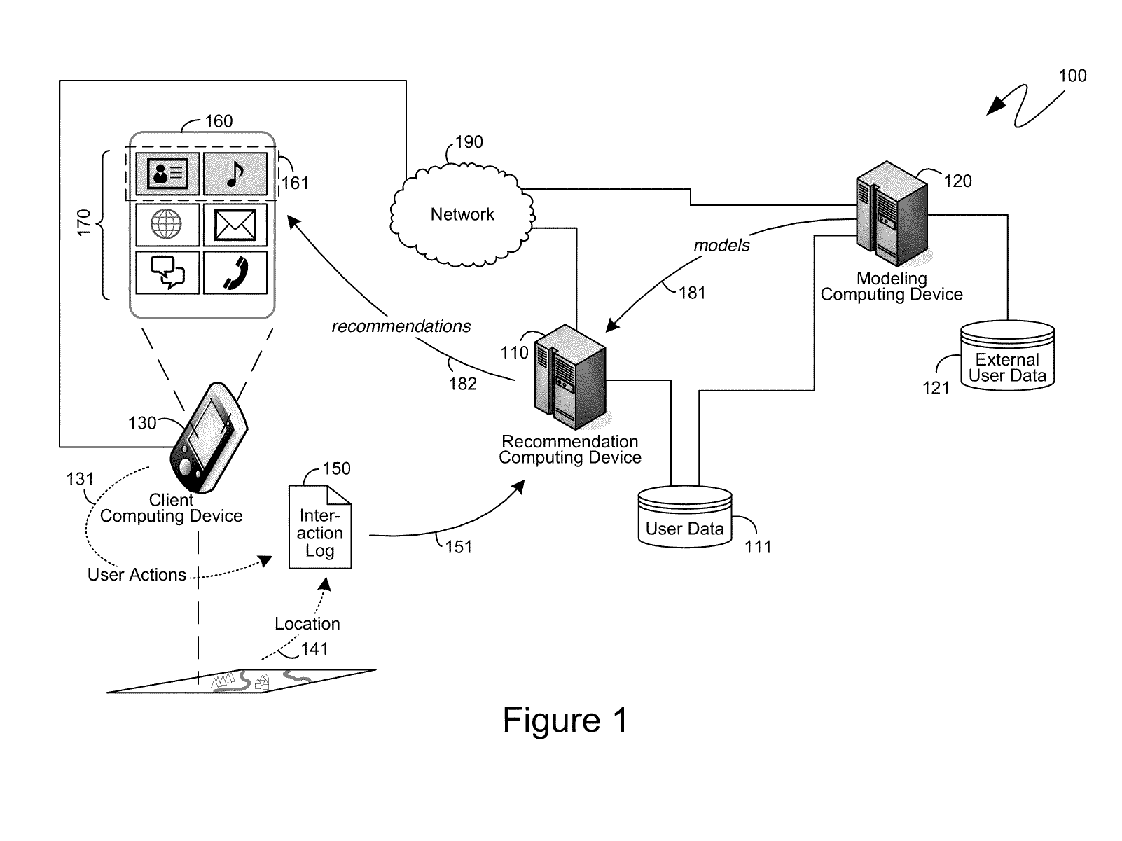

Turning to FIG. 1, an exemplary system 100 is shown, comprising a recommendation computing device 110, a modeling computing device 120 and a client computing device 130 in the form of a mobile personal computing device such as, for example, a smart phone, a tablet computing device, or other like mobile computing device. The various computing devices illustrated in the exemplary system 100 of FIG. 1 can be communicationally coupled to one another, as well as to other computing devices, via a network, such as the exemplary network 190 that is shown in FIG. 1. As will be recognized by one of skill in the art, while the descriptions below have been provided within the context of a mobile computing device, they are equally applicable to any type of client computing device, including laptop computing devices and desktop computing devices. In one embodiment, computer-executable instructions executing on the client computing device 130 can generate an interaction log 150 that can be utilized by the recommendation computing device 110 to make recommendations 182, which can be returned to the client computing device 130.

In one embodiment, the computer-executable instructions executing on the client computing device 140 can collect information that can define a current user context. For example, as illustrated in the exemplary system 100 of FIG. 1, the interaction log 150 can include user actions 131, such as a sequence of one or more content, such as application programs, accessed by the user, the order in which they were accessed, the time and day when they were accessed, and other like user action data. As also illustrated in FIG. 1, the interaction log 150 can include additional information, such as a geographic location 141 of the user when they were interacting with the client computing device 130 in the manner specified.

Information from the interaction log 150 can, in one embodiment, be continuously provided to a recommendation computing device 110, as illustrated by the communication 151. The recommendation computing device 110 can then utilize such information to make recommendations 182. More specifically, the recommendation computing device 110 can determine, based upon a current user context, as obtained from the interaction log 150, what content the user is likely to access next. Such content can then be proactively presented to the user, thereby saving the user the effort of having to identify and locate such content themselves. For example, the user of the client computing device 130 can commute to their place of employment via train, and, while standing on the platform waiting for the train, the user can utilize the client computing device 130 to first check their email, and then subsequently listen to music. In such an example, data from the interaction log 150 can be utilized to identify a correlation between the user's geographic location 141 and the user's actions 131. Subsequently, when the recommendation computing device 110 learns that the current user context of the user of the client computing device 130 is that the user is standing on the train platform and is accessing their email, the recommendation computing device 110 can provide a recommendation 182, identifying the music application program, since the recommendation computing device 110 can determine that the music application program is likely to be the next content accessed by the user. The user of the client computing device 130, in such an example, can, upon completing perusing their email, find the music application program prominently displayed on a user interface of the client computing device 130. The user will then be able to select the music application program in a more efficient manner. By prominently and proactively displaying the music application program, in the above example, the above-described mechanisms can aid the user, since the user no longer needs to manually search for such an application program. In addition, users can often become distracted by their surroundings and then require additional time to recall what activity they sought to perform next, especially when the relevant content, such as the music application program, is not currently being displayed to the user in the particular user interface being displayed by the client computing device. In further embodiments, described in detail below, users can be prominently and proactively presented with application programs that can be more useful to the user than existing application programs that the user currently has installed on the client computing device, thereby deriving further benefits.

One exemplary user interface for proactively providing content to a user, such as via the client computing device 130, is illustrated in the exemplary system 100 of FIG. 1 as the exemplary user interface 160. As illustrated, the exemplary user interface 160 can comprise an area 170 within which application programs, as one example, can be presented to the user of the client computing device 130 in the form of one or more icons, with each icon representing one application program. The exemplary user interface 160 can comprise, within that area 170, a defined area 161 within which icons of application programs recommended by the recommendation computing device 110 can be presented. Such a defined area 161 can include the presentation of recommended content in a form in which the importance of the content is visually indicated to the user, such as through sizing, colors, fonts, and other like cues. The defined area 161 can be oriented in any orientation and can, in one embodiment, be treated as part of the presentation of other applications within the area 170. In another embodiment, however, the defined area 161 can remain visible, or can be dynamically shown and hidden, even while the user is executing other application programs on the client computing device 130.

The determination, by the recommendation computing device 110, of which one or more application programs, or other content, the user of the client computing device 130 is likely to access next can be based on models 181 that can be provided by a modeling computing device 120, which can either be distinct from the recommendation computing device 110 or can be co-located there with, including being part of the single executing process that can perform the functionality of both the recommendation computing device 110 and the modeling computing device 120. The modeling computing device 120 can, in one embodiment, generate one or more models 181, correlating a current user context to content that the user is likely to subsequently access, based upon the user data 111 that can be collected, such as by the recommendation computing device 110, from the specific user to whom the recommendations 182 are being made. Thus, the recommendations made based upon such a model can be specific to a particular user. In another embodiment, the modeling computing device 120 can generate one or more models 181, correlating a current user context to content that the user is likely to subsequently access, based upon external user data 121 that can be collected from other users. In such another embodiment, the models based upon the external user data 121 can reflect, given a current user context, the content that an average user is likely to access next.

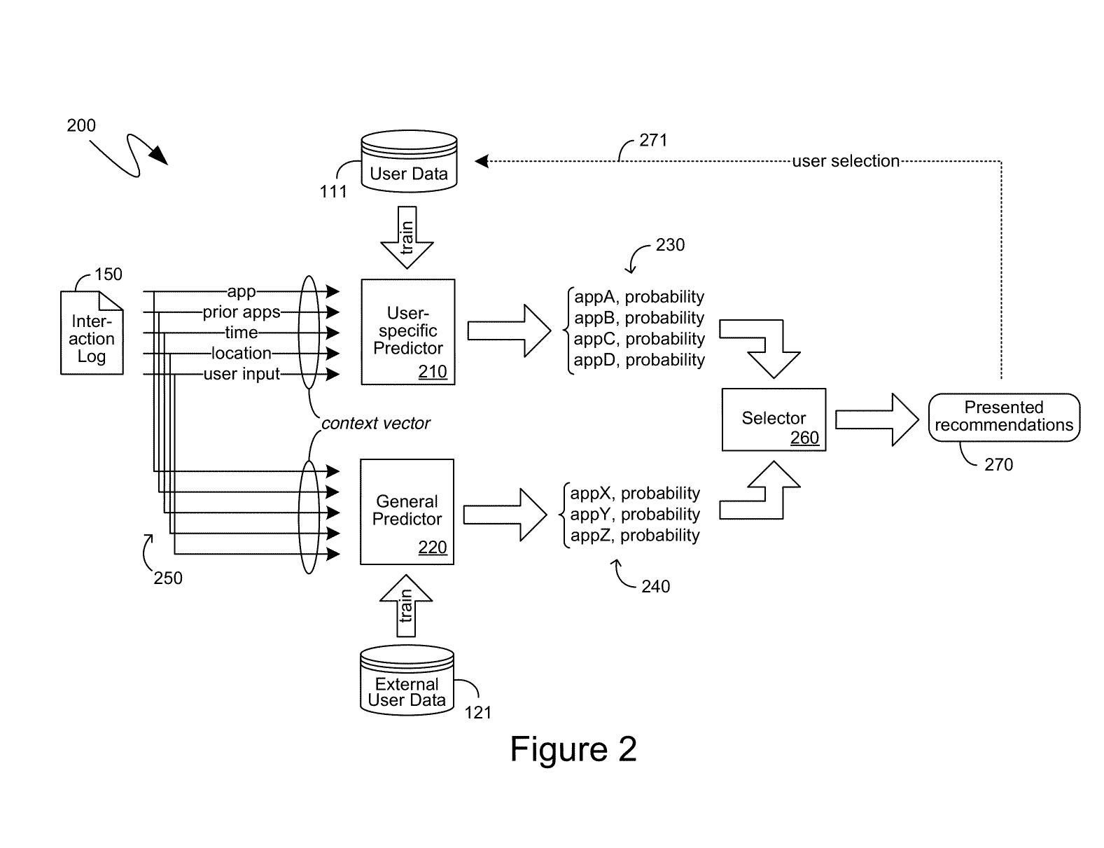

Turning to FIG. 2, system 200 shown therein illustrates an exemplary utilization of one or more models to predict, and recommend, content that the user is likely to subsequently access, given a current user context. As illustrated by FIG. 2, the current user context can be obtained in the form of a context vector 250 from data collected from a client computing device, such as the interaction log 150. A context vector can be one mechanism for defining a current user context. More specifically, the context vector can comprise multiple dimensions with each dimension being an aspect of the current user context that can be considered in determining what content the user is likely to subsequently access. Thus, as one example, one dimension of a context vector, such as the context vector 250, can be a current application that the user is utilizing. The magnitude of the context vector 250 along such a dimension can be equivalent to a unique value assigned to the particular application that the user is currently utilizing. As another example, another dimension of the context vector 250 can be a current time. Again, therefore, the magnitude of the context vector 250 along such a dimension can be equivalent to the value assigned to the current time. Other dimensions can, similarly, reflect a user's current location, prior applications the user launched or instantiated, applications that a user has installed, and other like user context information.

In one embodiment, one aspect of the current user context that can be considered in determining which content a user is likely to subsequently access, can be user input indicative of a desire or intention of the user. For example, a user searching for airline or hotel information may likely subsequently access their calendar in order to enter information regarding airline tickets or hotel reservations that the user may have made. As another example, a user searching for a particular band, or other like performing artist, may likely subsequently access a music application in order to listen to such a band. Such user input evidencing explicit user intent can be quantified and included as part of a context vector, such as the context vector 250.

The context vector 250 can be provided to a user-specific predictor 210 which can generate output 230 identifying one or more elements of content, such as one or more applications, that the user is likely to subsequently access, together with an identification of the probability, for each identified element of content, that the user will subsequently access such content. In one embodiment, as illustrated by the exemplary system 200 of FIG. 2, the user-specific predictor 210 can be trained using existing user data 111. Thus, for example, returning to the above example of a user standing on a train platform who first accesses their email and then subsequently accesses a music application, such user data 111 can be utilized to generate a user-specific predictor 210 that can, given a context vector 250 that has a magnitude along the dimensions corresponding to user location, time, and a currently accessed application that corresponds to a user standing on the train platform currently checking their email, generate an output listing of applications that the user is likely to subsequently access, with the identification of the music application being associated with a high probability.

The user-specific predictor 210 can be generated through any one of a number of statistical methodologies for defining such relationships. For example, the user-specific predictor 210 can be generated using known techniques such as Hidden Markov Models (HMMs). As another example, user-specific predictor 210 can be generated utilizing mechanisms based upon the frequency of defined occurrences. In yet another example, logistic regression models can be utilized to generate the user-specific predictor 210. In such an example, the user-specific predictor 210 can be trained utilizing stochastic gradient descent mechanisms.

Once the user-specific predictor 210 generates the output 230, a selector 260 can select one or more of the content identified in the output 230 to be presented as one of the presented recommendations 270 to the user of the computing device. For example, in one embodiment, the selector 260 can simply select the top three applications, or other content, from among the output 230, having the highest probability of being selected next by the user. In another embodiment, the selector 260 can apply a threshold such that no applications, or other content, is selected for presentation to the user if the probability of such content being selected next by the user is below the applied threshold.

Once the recommendations 270 are presented to the user, the user will have an opportunity to select one of those recommendations and such a user selection 271 can then become part of the user data 111 providing further training for the user-specific predictor 210. For example, if an application is among the recommendations 270 presented to the user, and the user selects such an application, such a user selection 271 can generate new user data 111 that can more closely associate that application with the context which was used to predict that this application will be launched next. By contrast, if the user did not select such an application, the user selection 271 that the user did make can generate new user data 111 that can less closely associate the recommended application with the preceding context, and can, instead, more closely associate the application the user did end up selecting with the context from which such an application was selected.

In one embodiment, in addition to utilizing a user-specific predictor 210 that is trained based upon the historical data collected from a specific user, a general predictor 220 can also be utilized to generate output 240 that can represent, colloquially, the content that an average user would select given equivalent context to that of the specific user to whom the recommendations 270 are being presented. The general predictor 220 can be trained in a manner analogous to that utilized to train the user-specific predictor 210, except that the general predictor 220 can be trained utilizing external user data 121, which can be analogous to the user data 111, except the external user data 121 can be collected from one or more users other than the user of the computing device to whom the recommendations 270 are being presented.

If a general predictor 220 is utilized, the selector 260 can, in one embodiment, select some, or all, of the content identified by the output 230 of the user-specific predictor 210 and some, or all, of the content identified by the output 240 of the general predictor 220 to form the set of recommendations 270 that can be presented to the user. For example, the selector 260 can form the recommendations 270 that are presented to the user by selecting the three most likely applications, from among the output 230, and the two most likely applications, from among the output 240. As another example, the selector 260 can select from among the output 230 and the output 240 based upon explicitly stated user preferences. For example, the user may specify that they only desire one application from among the output 240 of the general predictor 220, in which case the selector 260 can honor such an explicitly stated user preference. In one embodiment, the selector 260 can identify duplicates from among the output 230 and 240 and can ensure that such duplication is not included in the recommendations 270 that are presented to the user.

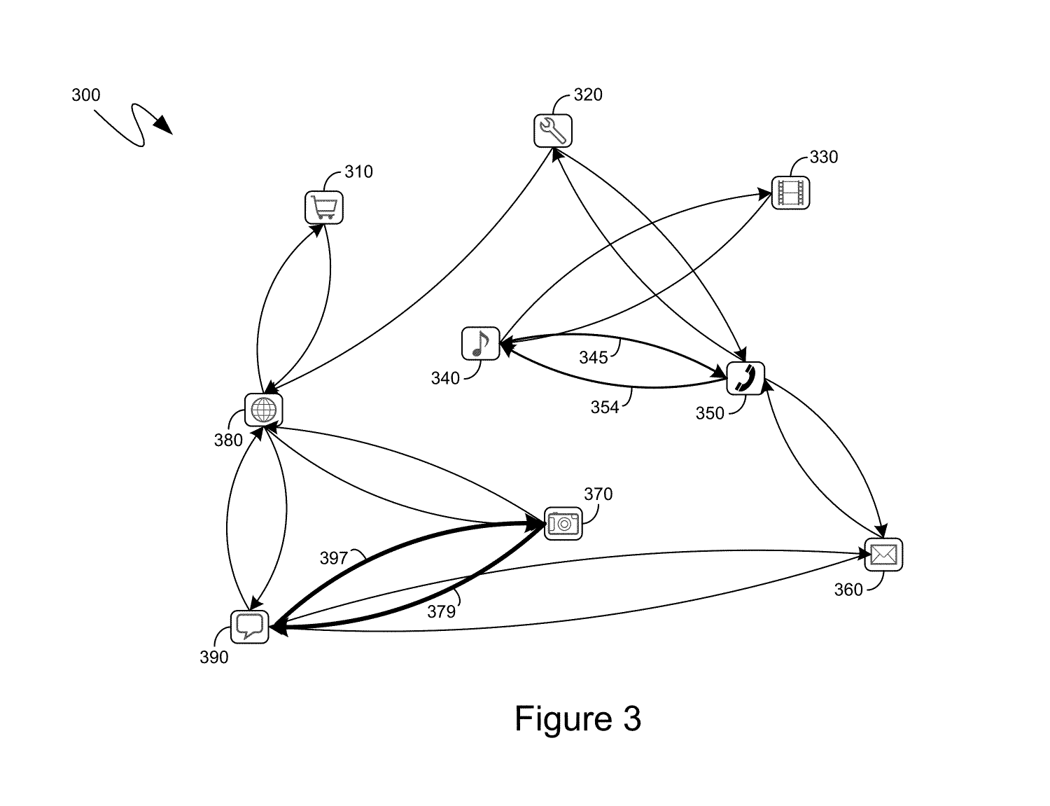

Turning to FIG. 3, the system 300 shown therein illustrates an exemplary semantical graph that can also be utilized to generate a correlation between a current user context and content that the user is likely to subsequently access. For example, a semantical graph, such as that exemplary shown in FIG. 3, can have, as its nodes, specific content, such as specific application programs. Thus, the semantical graph shown in the system 300 of FIG. 3 has, as its nodes, the applications 310, 320, 330, 340, 350, 360, 370, 380 and 390. Additionally, the edges between the nodes can represent connections between two or more applications. For example, in one embodiment, the edges between the nodes can represent temporal connections between two or more applications, indicating which application a user utilized next after utilizing a prior application.

A correlation between applications can thus be recognized from the edges that are found to exist, which can, themselves, be based upon historical data. More specifically, an edge can indicate the existence of at least one transition between a first node from which the edge starts and a second node where the edge ends, such as, for example, a transition, by a user, from using one application program to next using another, different application program. The weighting applied to the edges can then be based on a quantity of such transitions, which can again be derived from historical data. For example, and with reference to the exemplary system 300 of FIG. 3, a higher weighting can be applied to the edges 397 and 379 if a user often directly transitions between the application 390 in the application 370. As another example, a higher weighting can also be applied to the edges 345 and 354 if a user often directly transitions between the application 340 and the application 350. The weighting applied to the edges 397 and 379 can be greater than that applied to the edges 345 and 354 to represent the user more often directly transitions between the applications 390 and 370 than they do between the applications 340 and 350.

Utilizing such a semantical relationship, a correlation can be established from which an application that will be subsequently accessed by the user can be predicted given a current user context, which can, as explained above, include an application that the user is currently utilizing. For example, and with reference to exemplary system 300 of FIG. 3, given the current user context in which the user is utilizing the application 390, it can be determined to be more likely that the user will next utilize the application 370 than, for example, the applications 360 or 380. Thus, consequently, the application 370 can be recommended to the user, as opposed to, for example, the applications 360 or 380.

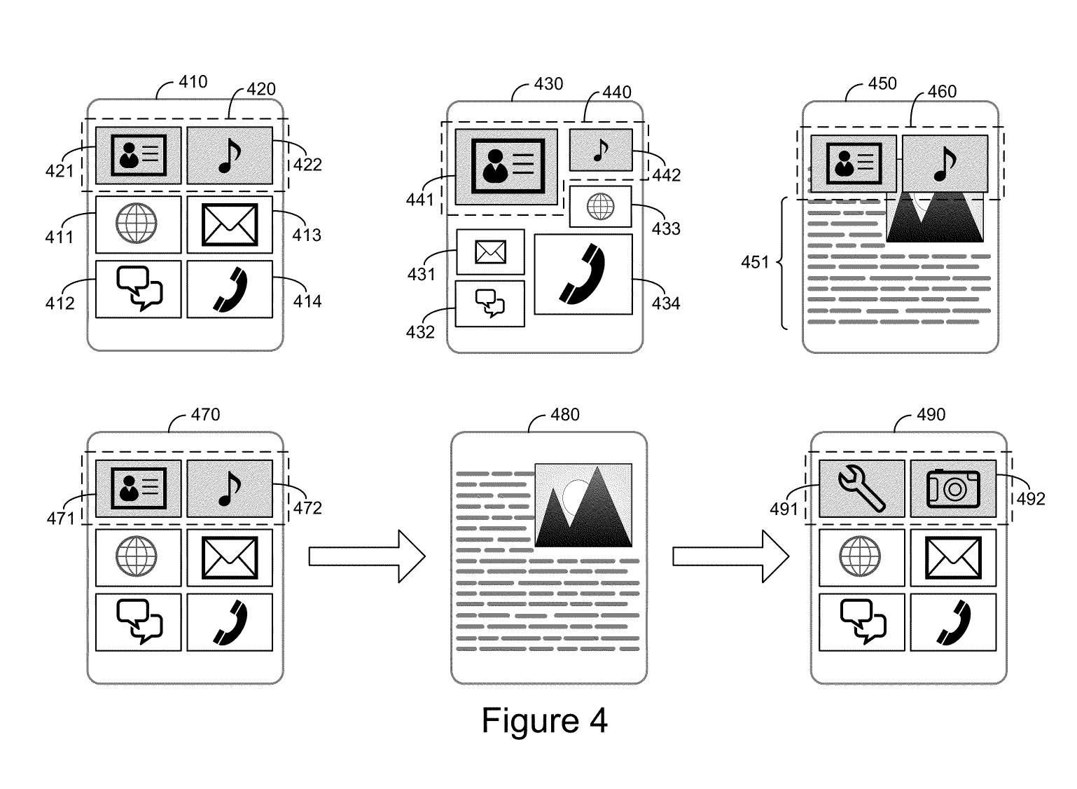

Turning to FIG. 4, exemplary user interfaces for presenting suggested content to a user are illustrated. In one exemplary user interface, such as the exemplary user interface 410, a defined area 420 can be established within which content can be recommended to a user. Thus, for example, user interface 410, within which a user can have established icons for application programs 411, 412, 413 and 414, can also comprise icons for application programs 421 and 422 that can represent content that was recommended to the user and presented to the user for the user's convenience based upon an expectation that the user would next seek to access such content. In one embodiment, the defined area 420 can be within an existing content presentation area, such as, for example, one or more screens of application program icons, or a continuous scroll of application program icons. Thus, for example, in such an embodiment, if the user were to scroll the application icons upward or downward, such as through a touch interface, the defined area 420 could scroll with such application icons such that it was, for example, always positioned immediately above the application icons 411 and 413. As another example, in such an embodiment, if the user were to transition to another screen of application icons, such as through a swipe touch gesture, the defined area 420 could transition with the screen of icons comprising the icons 411, 412, 413 and 414. In another embodiment, however, the defined area 420 can be in a fixed location that can be independent of the position of application icons or other like indicators of content around the defined area 420. Thus, for example, in such another embodiment, if the user were to scroll the applications icons upward or downward, the defined area 420, and content presented therein, such as, for example, the icons 421 and 422, could remain fixed with the other icons, such as the icons 411, 412, 413 and 414 scrolling “underneath” the defined area 420.

In another embodiment, such as that illustrated by the exemplary user interface 430, visual cues can be provided to the user as to the importance, or weight, assigned to particular content. Such visual cues can be in the form of colors, fonts, highlighting, special effects, or other like visual cues. In the specific example shown in the exemplary user interface 430 of FIG. 4, importance can be illustrated through the size of the icon associated with particular content, such as a particular application program. Thus, the application icon 434 can be considered to be more important than the application icons 431, 432 and 433. In such an embodiment, a defined area 440 can be dynamically resized to accommodate icons of varying size, shape, color, and other like visual cues. Thus, for example, the icon 441 can be larger than the icon 442, both of which can represent content presented to the user in anticipation of the users accessing of such content, but the icon 441 can represent content for which there is, for example, a higher probability that the user will access such content next, or for which there is another like higher priority indicator.

In yet another embodiment, such as that illustrated by the exemplary user interface 450, content that it is anticipated the user will subsequently access can be presented within a defined area 460 even within the context 451 of an application program that the user is currently utilizing. For example, to avoid distracting the user while utilizing of the application program presenting the application program context 451, the defined area 460 can be presented only in response to specific user action, or inaction. A user could trigger the presentation of the defined area 460, and the recommendations contained therein, by, for example, performing a swipe touch gesture. As another example, the defined area 460 can be presented in response to a period of user interaction, which can be deemed to signify that the user has ceased interacting with the application program presenting the application program context 451.

The sequence of user interfaces 470, 480 and 490 illustrates one exemplary mechanism by which a defined area, such as the defined areas described in detail above, can be utilized to present suggested content to a user reflecting what the system anticipates the user will next desire to access. In particular, the user interface 470 can include application program icons 471 and 472 that can represent applications that it is deemed the user will subsequently access. The user can then access, in the particular example illustrated in FIG. 4, an application program that can present a user interface 480. The application program accessed by the user need not be one of the application programs whose icons 471 and 472 were presented within the defined area 470. Nevertheless, the user's access of the application presenting the user interface 480 can generate a new user context from which new content, such as new application programs, can be deemed to be the content that the user will most likely access next. Consequently, upon exiting the application presenting the user interface 480, the user can be presented with an interface 490 that can be equivalent to the user interface 470 except that the icons 471 and 472 can no longer be presented and, instead, different applications, represented by the icons 491 and 492 can be presented. The applications represented by the icons 491 and 492 can be content that it was deemed the user was most likely to access next after accessing the application that presented the user interface 480. In such a manner, at least a portion of a user interface can provide a user with easy access to content that the user is likely to access next. Thus, in the specific example shown along the bottom of FIG. 4, if a user, upon completing their interaction with the application presenting the user interface 480, next desired to use the application represented by the icon 492, the user would not be required to scroll along searching for such an application, nor to swipe through multiple screens of application icons to find such an application. Instead, the application represented by the icon 492 would already be proactively presented to the user in a manner that the user could efficiently access such content without having to waste time searching for it.

In one embodiment, although not specifically illustrated by the exemplary user interfaces of FIG. 4, content that can be recommended to the user can be content that the user does not already have installed on their computing device. For example, as will be known by those skilled in the art, users can obtain application programs, and other content, from online sources, often centralized sources such as a centralized application program store operated by and operating system or mobile computing device vendor. In such instances, the content available through such a store can be finite and, consequently, the above-described mechanisms can be utilized to identify such content as content that the user would likely seek to access next. For example, such a determination can be made based upon historical data collected from other users. Thus, if other users utilizing a particular application often subsequently utilize another application, that other application can be suggested to the user even if the user does not currently have such other application already installed on their computing device. In such an embodiment, visual cues or other indicators can be utilized to signify to the user that the suggested content is not already locally stored on the user's computing device. For example, such content can be indicated utilizing a different shading, color, font, or other explicit indicator indicating that such content would need to be acquired by the user, such as by purchasing or downloading it from a content store. As one variant, free content can be distinguished from content that a user would be required to purchase.

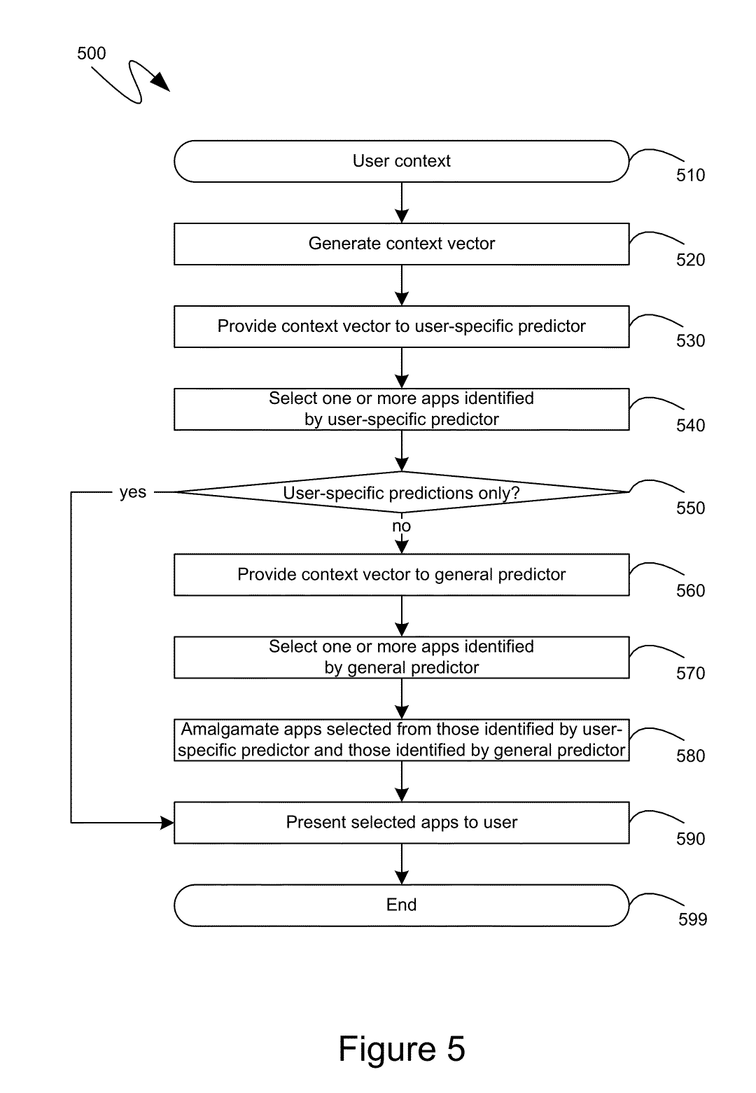

Turning to FIG. 5, the flow diagram 500 shown therein illustrates an exemplary series of steps that can be performed in order to proactively present content that it is anticipated the user will subsequently access. Initially, at step 510, a user context can be received. As indicated previously, such a user context can include an application that the user is currently utilizing, a current time and day, the user's current location, other applications, or content, that the user has previously accessed, applications or content that the user currently has installed on their computing device, and other like contextual input. Subsequently, at step 520, a context vector can be generated. As indicated previously, a context vector can comprise dimensions for each contextual input that can be utilized as a basis on which a correlation can be made between a user's current context and content that the user will subsequently access. At step 530, the context vector generated at step 520 can be provided to a user-specific predictor, which can output a listing of content and an indication of the probability, for each such content identified, that a user will next select such content given the context received at step 510. Subsequently, at step 540 one or more of the content identified by the user-specific predictor, at step 530, can be selected to be presented to a user. As indicated previously, such a selection can be based on a quantity, such as selecting the top three most likely content, can be based on a defined threshold, such as selecting any content having a probability of next being selected by the user that is greater than the threshold, or other like variants thereof.

If only user-specific suggestions are to be provided, such as can be determined at step 550, processing can proceed to step 590 and the content identified at step 540 can be presented to the user, such as in the manner described in detail above. The relevant processing can then end step 599. Conversely, if, at step 550, it is determined that suggestions based on average users are also to be provided to the user, such as due to an explicit user option indicating that the user desires to receive such suggestions, processing can proceed to step 560 at which point the context vector generated at step 520 can be provided to a general predictor, such as that described in detail above. The general predictor can, like the user-specific predictor, output one or more content and an indication of the probability, for each such content identified, that the user will next select such content given the context received at step 510. One or more of the content output by the general predictor, at step 560, can be selected at step 570 for presentation to the user. As indicated previously, such as selection can be based on quantity, defined thresholds, and other like selection criteria. At step 580, the content selected at step 540 can be amalgamated with the content selected at step 570 for presentation to the user. Such an amalgamation can include the removal of any duplicates, and an appropriate ordering, such as, for example, presenting all of the content selected at step 540 independently of the content selected at step 570, or, alternatively, interleaving the content selected at step 540 and the content selected at step 570 according to one or more criteria, such as the determined probability that the user will next select such content. Such an amalgamation can then be presented to the user at step 590. The relevant processing can then end at step 599.

In one embodiment, not specifically illustrated by the flow diagram 500 of FIG. 5, the user context 510 need not comprise a current user context but rather can comprise relevant information about the user, including information affirmatively declared by the user, and information inferred from the user's actions. Such relevant information, both inferred and declared, can be obtained from online user profiles, prior user actions online and the like. In such an embodiment, content proactively presented to the user need not be content that the user would access next, given their current user context, but rather can be content which the user would access next if they were aware of one or more factors that the user may not, in fact, be aware of For example, a user can be a golf fan. Such information can be obtained from information provided directly by the user, such as an explicit indication that the user is a golf fan that the user made through social networking media or other like services. Alternatively, such information can be inferred, such as from a user's prior purchases of tickets to golfing tournaments. Continuing with such a example, an important golfing tournament may be commencing and there may exist an application program specifically designed to enable users to watch such a tournament and otherwise keep track of scores, their favorite players, or other like information. In such an instance, such an application can be suggested to the user because it could be determined that the user would likely instantiate such an application if the user were aware that such an application existed and that the golfing tournament was commencing. Thus, in such an embodiment, suggested content that is proactively provided to a user can be based on a user's context that includes information about the user that can either be explicitly declared by the user or can be inferred from the user's actions.

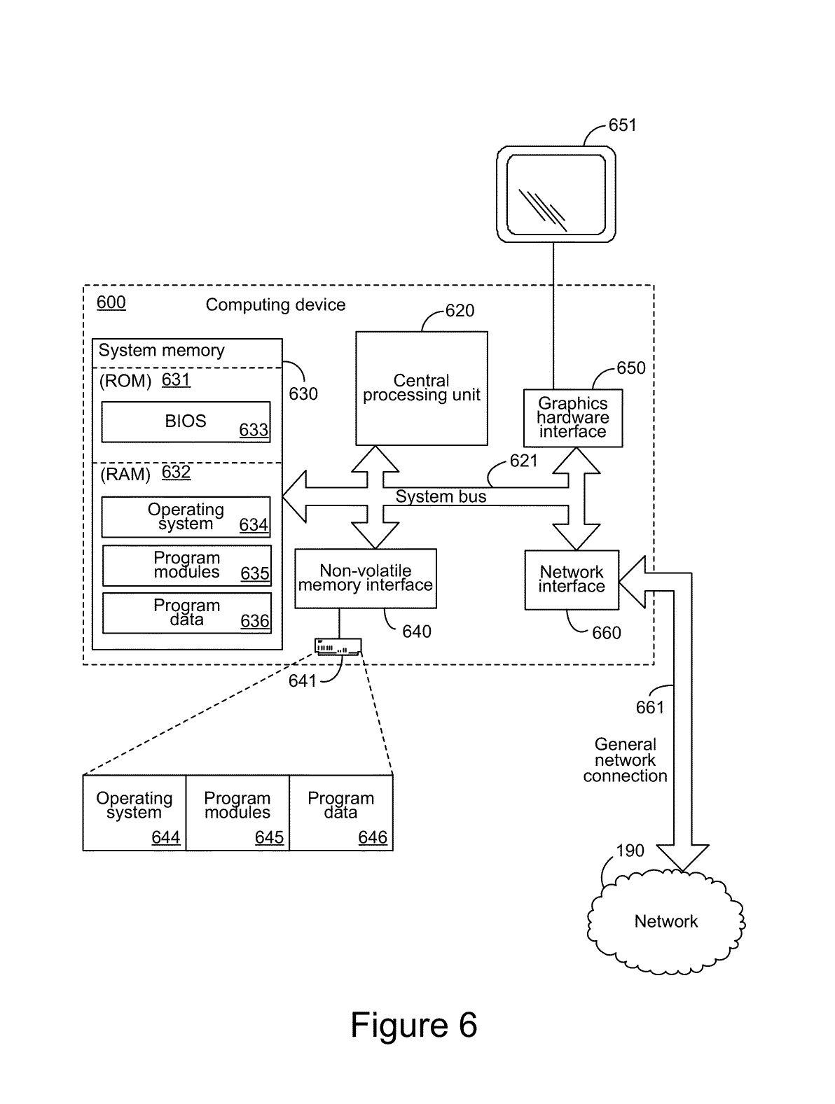

Turning to FIG. 6, an exemplary computing device 600 for implementing the above-described mechanisms is illustrated. The exemplary computing device 600 can be any one or more of the computing devices referenced above, such as those illustrated in FIG. 1, including, for example, the computing devices 110, 120 and 130, whose operation was described in detail above. The exemplary computing device 600 of FIG. 6 can include, but is not limited to, one or more central processing units (CPUs) 620, a system memory 630, that can include RAM 632, and a system bus 621 that couples various system components including the system memory to the processing unit 620. The system bus 621 may be any of several types of bus structures including a memory bus or memory controller, a peripheral bus, and a local bus using any of a variety of bus architectures. The computing device 600 can optionally include graphics hardware, such as for the display of obscured content in the situations described in detail above. The graphics hardware can include, but is not limited to, a graphics hardware interface 650 and a display device 651. Depending on the specific physical implementation, one or more of the CPUs 620, the system memory 630 and other components of the computing device 600 can be physically co-located, such as on a single chip. In such a case, some or all of the system bus 621 can be nothing more than silicon pathways within a single chip structure and its illustration in FIG. 6 can be nothing more than notational convenience for the purpose of illustration.

The computing device 600 also typically includes computer readable media, which can include any available media that can be accessed by computing device 600 and includes both volatile and nonvolatile media and removable and non-removable media. By way of example, and not limitation, computer readable media may comprise computer storage media and communication media. Computer storage media includes media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computing device 600. Computer storage media, however, does not include communication media. Communication media typically embodies computer readable instructions, data structures, program modules or other data in a modulated data signal such as a carrier wave or other transport mechanism and includes any information delivery media. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 630 includes computer storage media in the form of volatile and/or nonvolatile memory such as read only memory (ROM) 631 and the aforementioned RAM 632. A basic input/output system 633 (BIOS), containing the basic routines that help to transfer information between elements within computing device 600, such as during start-up, is typically stored in ROM 631. RAM 632 typically contains data and/or program modules that are immediately accessible to and/or presently being operated on by processing unit 620. By way of example, and not limitation, FIG. 6 illustrates the operating system 634 along with other program modules 635, and program data 636, which can include the above referenced network browser.

The computing device 600 may also include other removable/non-removable, volatile/nonvolatile computer storage media. By way of example only, FIG. 6 illustrates the hard disk drive 641 that reads from or writes to non-removable, non-volatile media. Other removable/non-removable, volatile/non-volatile computer storage media that can be used with the exemplary computing device include, but are not limited to, magnetic tape cassettes, flash memory cards, digital versatile disks, digital video tape, solid state RAM, solid state ROM, and the like. The hard disk drive 641 is typically connected to the system bus 621 through a non-removable memory interface such as interface 640.

The drives and their associated computer storage media discussed above and illustrated in FIG. 6, provide storage of computer readable instructions, data structures, program modules and other data for the computing device 600. In FIG. 6, for example, hard disk drive 641 is illustrated as storing operating system 644, other program modules 645, and program data 646. Note that these components can either be the same as or different from operating system 634, other program modules 635 and program data 636. Operating system 644, other program modules 645 and program data 646 are given different numbers hereto illustrate that, at a minimum, they are different copies.

The computing device 600 can operate in a networked environment using logical connections to one or more remote computers. The computing device 600 is illustrated as being connected to a general network connection 661 through a network interface or adapter 660 which is, in turn, connected to the system bus 621. In a networked environment, program modules depicted relative to the computing device 600, or portions or peripherals thereof, may be stored in the memory of one or more other computing devices that are communicatively coupled to the computing device 600 through the general network connection 661. It will be appreciated that the network connections shown are exemplary and other means of establishing a communications link between computing devices may be used.

As can be seen from the above description, mechanisms for proactively providing content, such as applications, to users in order to save the users the effort of searching for it have been presented. In view of the many possible variations of the subject matter described herein, we claim as our invention all such embodiments as may come within the scope of the following claims and equivalents thereto.

We claim:

1. A method for proactively providing content to a user, the method comprising the steps of:
receiving a user context comprising an application currently being utilized by the user on a client computing device;
determining at least one application that is anticipated to next be utilized by the user;
determining a probability that each of the determined at least one application will next be utilized by the user;
selecting one or more of the determined at least one application based on the determined probability; and
proactively presenting the selected one or more applications to the user.

2. The method of claim 1, wherein the user context further comprises at least one of a current time, a current day or a user's geographic location.

3. The method of claim 1, wherein the selected one or more applications are already installed on the client computing device.

4. The method of claim 1, wherein at least one of the selected one or more applications is not already installed on the client computing device; and wherein further the proactively presenting the selected one or more applications comprising providing an indicator to the user that the at least one of the selected one or more applications is to be acquired prior to the user being able to execute it on the client computing device.

5. The method of claim 1, wherein the determining the at least one application that is anticipated to next be utilized by the user is based on prior historical data of the user's utilization of applications on the client computing device.

6. The method of claim 5, wherein the determining the at least one application that is anticipated to next be utilized by the user is also based on prior historical data of other users' utilization of applications on computing devices other than the client computing device.

7. The method of claim 1, wherein the determining the at least one application that is anticipated to next be utilized by the user is based on a semantical relationship of the user's utilization of applications on the client computing device.

8. The method of claim 1, wherein the proactively presenting the selected one or more applications comprises displaying icons representing the selected one or more applications within a defined area within a user interface being presented by the client computing device.

9. The method of claim 8, wherein the user interface is utilizable to launch applications on the client computing device.

10. A graphical user interface, generated on a display device by a computing device, proactively providing content to a user, the user interface comprising:
one or more application icons selectable by a user to launch one or more applications, associated with the one or more application icons, on the computing device; and
a defined area among the one or more application icons within which only anticipated application icons are presented, each anticipated application icon being associated with an anticipated application that was determined would be next utilized by the user based on an application that was exited immediately prior to a presentation of the graphical user interface.

11. The graphical user interface of claim 10, further comprising an anticipated application icon comprising a visual indicator that an anticipated application with which the anticipated application icon is associated is not installed on the computing device.

12. The graphical user interface of claim 11, wherein the anticipated application icon further comprises a visual indicator signifying whether the anticipated application with which the anticipated application icon is associated is free or whether it is purchasable.

13. The graphical user interface of claim 10, wherein the defined area maintains its relationship to surrounding ones of the one or more application icons.

14. The graphical user interface of claim 10, wherein the defined area comprises at least two anticipated application icons, and wherein a first anticipated application icon is larger than a second anticipated application icon, the first anticipated application icon being associated with a first anticipated application that is deemed to be more likely to be next utilized by the user than a second anticipated application that is associated with the second anticipated application icon.

15. The graphical user interface of claim 14 wherein the defined area is presented within a second user interface, the second user interface being presented by an application execution on the computing device.

16. One or more computer-readable media comprising computer-executable instructions for proactively providing content to a user of a client computing device, the computer-executable instructions performing steps comprising:
generating, from prior historical data of the user's utilization of the client computing device, a user-specific predictor of a subsequent content to be consumed by the user based on a current user context;
receiving the current user context;
generating a context vector from the current user context, wherein each dimension of the context vector represents an aspect of the current user context; and
utilizing the user-specific predictor to convert the generated context vector into output comprising an identification of at least one application that is anticipated to next be utilized by the user and an identification of a probability of the at least one application being next utilized by the user.

17. The computer-readable media of claim 16, comprising further computer-executable instructions for:
selecting one or more of the at least one application based on the identified probability; and
proactively presenting the selected one or more applications to the user.

18. The computer-readable media of claim 16, comprising further computer-executable instructions for:
generating, from prior historical data of other users' utilizations of other computing devices, a generic predictor of a subsequent content to be consumed by an average user based on the current user context;
utilizing the generic predictor to convert the generated context vector into output comprising an identification of at least one application that is anticipated to next be utilized by an average user having a same context as the current user context and an identification of a probability of the at least one application being next utilized by the average user.

19. The computer-readable media of claim 18, comprising further computer-executable instructions for:
selecting one or more of the at least one application that is anticipated to next be utilized by the user based on the identified probability;
selecting one or more of the at least one application that is anticipated to next be utilized by the average user based on the identified probability;
amalgamating the selected applications; and
proactively presenting the selected applications to the user.

20. The computer-readable media of claim 19, wherein the computer-executable instructions for the selecting the one or more of the at least one application that is anticipated to next be utilized by the user based on the identified probability and the computer-executable instructions for selecting one or more of the at least one application that is anticipated to next be utilized by the average user based on the identified probability are both informed by explicit user preferences.
